(19) United States
(12) Patent Application Publication
(10) Pub. No.: US 2008/0088223 A1
(43) Pub. Date: Apr. 17, 2008

(54) Flat panel display and its method of manufacture

(76) Inventors: Tae-Won Jeong, Yongin-si (KR); Shang-Hyeun Park, Yongin-si (KR); Jeong-Na Heo, Yongin-si (KR)

Correspondence Address: Robert E. Bushnell, Suite 300, 1522 K Street, N. W., Washington, DC, 20005-1202, US

(21) Appl. No.: 11/812,755

(22) Filed: Jun. 21, 2007

(30) Foreign Application Priority Data
Oct. 11, 2006 (KR) 10-2006-0098868

(51) Int. Cl. H01J 63/04; H01J 9/00

(52) U.S. Cl. 313/496; 445/24

(57) ABSTRACT

A flat panel display includes: an electron emission portion to emit electrons frontward; and a light emission portion, arranged on a front portion of the electron emission portion, to emit visible light rays frontward; the light emission portion including: a transparent front substrate to project the visible light rays toward the front portion; a phosphor layer arranged on a rear surface of the front substrate, the phosphor layer emitting visible light upon receiving electrons emitted from the electron emission portion; and a flat metal reflective layer arranged between the phosphor layer and the electron emission portion.

### CLAIM OF PRIORITY

This application makes reference to, incorporates the same herein, and claims all benefits accruing under 35 U.S.C.§119 from an application for FLATPANEL DISPLAY DEVICE AND METHOD OF MANUFACTURING THE SAME earlier filed in the Korean Intellectual Property Office on the 11^{th} of Oct. 2006 and there duly assigned Serial No. 10-2006-0098868.

### BACKGROUND OF THE INVENTION

1. Field of the Invention

The present invention relates to a flat panel display, and more particularly, the present invention relates to a flat panel display including a metal reflective layer and a method of manufacturing the flat panel display.

2. Description of the Related Art

Flat panel displays are flat display panels that can substitute for conventional Cathode Ray Tubes (CRTs), and have advantages such that a large screen can easily be realized and a small installation space is required, for example, Liquid Crystal Displays (LCDs), Plasma Display Panels (PDPs), and Field Emission Displays (FEDs).

FIG. 1 is a cross-sectional view of a flat panel display, and in particular, an FED in accordance with U.S. Pat. No. 6,630,786.

Referring to FIG. 1, the flat panel display 10 includes an electron emission portion 11 and a light emission portion 20 located in front of the electron emission portion 11. The electron emission portion 11 includes a rear substrate 12 and electron emission sections 14 emitting electrons toward the light emission portion 20.

The light emission portion 20 includes a front substrate 21 that is transparent so that visible light rays can be projected frontward through the front substrate 21, phosphor layers 23 formed on the front substrate 21 as a plurality of line shapes, and barrier ribs 25 separating the lines of the phosphor layer 23 to prevent colors from mixing with each other. In addition, the light emission portion includes a metal reflective layer 28 formed on the phosphor layer 23 and the barrier ribs 25.

When electrons are emitted from the electron emission sections 14 of the electron emission portion 11 toward the front portion, the electrons transmit through the metal reflective layer 28 and are incident into the phosphor layer 23. The phosphor layer 23 emits visible light rays due to the energy of the incident electrons, and the emitted visible light rays transmit through the transparent front substrate 21 and are projected frontward. Visible light rays proceeding backward among the emitted visible light rays are reflected by the metal reflective layer 28 and then are projected frontward.

However, the thicknesses of the barrier rib 25 and the phosphor layer 23 stacked on the front substrate 21 are different from each other, and the metal reflective layer 28 is formed by depositing a metal on the barrier ribs 25 and the phosphor layer 23. Therefore, as shown in FIG. 1, the metal reflective layer has an irregular surface along the shapes of the barrier ribs 25 and the phosphor layers 23. As described above, the rough metal reflective layer 28 having the irregular surface diffusively reflects the visible light rays emitted from the phosphor layers 23, and thus, a reflection efficiency is degraded and a brightness of the flat panel display is degraded. In addition, an electric arc may occur due to a surface electric field distortion on the irregular surface of the metal reflective layer 28, and thus, the flat panel display 10 may be damaged.

### SUMMARY OF THE INVENTION

The present invention provides a flat panel display having an improved emission uniformity and a brightness, and a method of manufacturing the flat panel display.

The present invention also provides a flat panel display maintaining a stable surface electric field so as to prevent an arc from occurring, and a method of manufacturing the flat panel display.

According to one aspect of the present invention, a flat panel display is provided including: an electron emission portion to emit electrons frontward; and a light emission portion, arranged on a front portion of the electron emission portion, to emit visible light rays frontward, the light emission portion including: a transparent front substrate to project the visible light rays toward the front portion; a phosphor layer arranged on a rear surface of the front substrate, the phosphor layer emitting visible light upon receiving electrons emitted from the electron emission portion; and a flat metal reflective layer arranged between the phosphor layer and the electron emission portion.

The metal reflective layer is preferably spaced apart from the phosphor layer. A distance between the metal reflective layer and the phosphor layer is preferably in a range greater than 0 μm and less than 100 μm. The metal reflective layer preferably includes aluminum.

The phosphor layer preferably includes a plurality of lines.

The flat panel display preferably further includes barrier ribs to separate adjacent lines of the phosphor layer. The metal reflective layer is preferably attached to and supported by the barrier ribs. The metal reflective layer preferably includes a polymer layer stacked evenly on the phosphor layer, and metal particles arranged on the polymer layer. The metal reflective layer is preferably formed by arranging a metal transfer film, including a polymer layer and a metal layer formed by depositing metal particles on the polymer layer, on the phosphor layer so that the metal layer faces the phosphor layer, and removing the polymer layer in the metal transfer film.

According to another aspect of the present invention, a method of manufacturing a flat panel display is provided, the method including: forming a phosphor layer, to emit visible light on receiving electrons, on a rear substrate of a transparent front substrate; forming a flat metal reflective layer on the phosphor layer; and arranging an electron emission portion, to emit electrons onto the phosphor layer, on the front substrate, the electron emission portion being spaced apart from the metal reflective layer.

The metal reflective layer is preferably spaced apart from the phosphor layer. A distance between the metal reflective layer and the phosphor layer is preferably in a range greater than 0 μm and less than 100 μm. The metal reflective layer includes aluminum.

The phosphor layer is preferably formed either by spin-coating a slurry of a phosphor material on the rear surface of the front substrate, or by screen-printing the phosphor material on the rear surface of the front substrate. The phosphor layer preferably includes a plurality of lines.

The method preferably further includes forming barrier ribs to separate adjacent lines of the phosphor layer. The metal reflective layer is preferably attached to and supported by the barrier ribs. The barrier ribs are preferably formed by screen-printing one material, selected from a group consisting of polymers, inorganic materials, and metallic materials, on the rear surface of the front substrate.

Forming the metal reflective layer preferably includes evenly stacking a polymer layer on the phosphor layer and arranging metal particles on the polymer layer. Forming the metal reflective layer preferably includes: arranging a metal transfer film, including a polymer layer and a metal layer formed by depositing metal particles on the polymer layer, on the phosphor layer so that the metal layer faces the phosphor layer; and removing the polymer layer in the metal transfer film.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a cross-sectional view of a flat panel display;

FIG. 2 is a cross-sectional view of a flat panel display according to an embodiment of the present invention;

FIGS. 3A and 3B are photographs of the emissions of a flat panel display including a metal reflective layer and a flat panel display without a metal reflective layer;

FIGS. 4A and 4B are microphotographs of a metal reflective layer having a relatively rough surface, and a metal reflective layer having a relatively smooth surface;

FIG. 5 is a graph of brightnesses of a flat panel display without a metal reflective layer, a flat panel display including a metal reflective layer having a rough surface, and a flat panel display having a smooth surface; and

FIGS. 6A through 6C are cross-sectional views sequentially illustrating processes of manufacturing the flat panel display of FIG. 2.

### DETAILED DESCRIPTION OF THE INVENTION

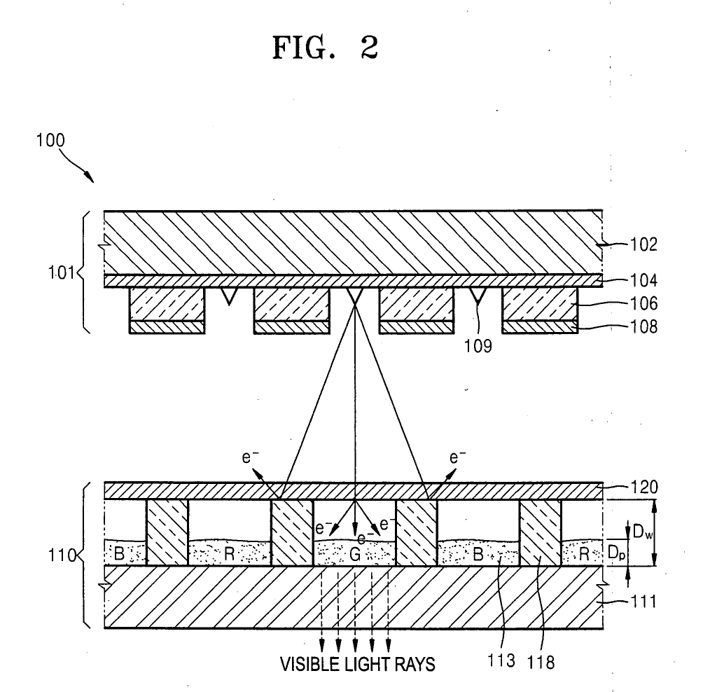

FIG. 2 is a cross-sectional view of a flat panel display according to an embodiment of the present invention.

Referring to FIG. 2, a flat panel display 100 according to the current embodiment is a Field Emission Display (FED), and includes an electron emission portion 101 for emitting electrons (e−) frontward, and a light emission portion 110 located in front of the electron emission portion 101. The electron emission portion 101 and the light emission portion 110 are spaced apart from each other by tens of ˜hundreds of mm, and a spacer (not shown) can be disposed between the electron emission portion 101 and the light emission portion 110 in order to maintain the space between the electron emission portion 101 and the light emission portion 110.

The electron emission portion 101 includes a rear substrate 102, and a cathode 104, an insulating layer 106, and gates 108 that are sequentially stacked on a front surface of the rear substrate 102. Emitter holes exposing the cathode 104 are formed on the insulating layer 106, and emitters 109 that are electron emission sources are formed in the emitter holes. The emitters 109 can be formed of, for example, Carbon NanoTubes (CNTs). When a Direct Current (DC) high voltage of 10 through 15 kV is supplied between the cathode 104 and the gate 108, electrons (e−) are emitted from the emitters 109 toward the light emission portion 110.

The light emission portion 110 includes a transparent front substrate 111 that is formed of a transparent material, for example, a glass, a phosphor layer 113 formed on a rear surface of the front substrate 111, and a flat metal reflective layer 120 disposed between the phosphor layer 113 and the electron emission portion 101. The phosphor layer 113 is formed of a phosphor material emitting visible light rays on receiving electrons (e−) having energies, and includes red lines for emitting red (R) light, green lines for emitting green (G) light, and blue lines for emitting blue (B) light, which are alternately arranged.

The flat panel display 100 further includes barrier ribs 118 for separating the adjacent lines of the phosphor layer 113. When some of the electrons (e−) emitted from a certain emitter 109 proceed toward adjacent phosphor layer 113, not toward the corresponding phosphor layer 113, the barrier ribs 118 blocks the electrons (e−) separated from the path so as not to be incident into the adjacent phosphor layer 113. Therefore, a color mixture with the adjacent phosphor layer 113 can be prevented, and thus, contrast can be improved. A thickness Dw of the stacked barrier rib 118 is about 50 μm, and may be thicker than a thickness Dp of the stacked phosphor layer 113.

The metal reflective layer 120 reflects the visible light rays that are emitted from the phosphor layer 113 excited by the electrons (e−) and proceed toward the rear portion of the flat panel display 110 to project the visible light rays toward the front portion, and performs as an anode applying conductivity to the phosphor layer 113. The metal reflective layer 120 must have a high transmittance for the electrons (e−) and good reflection characteristics. In the current embodiment, the metal reflective layer 120 is formed of aluminum (Al). Since the aluminum has a low density, the electrons (e−) can be transmitted through the aluminum easily. The aluminum (Al) can be easily fabricated to be thin, and a stiffness of the layer can be high due to an oxide (Al₂O₃) formed on the surface of the Al upon contacting air.

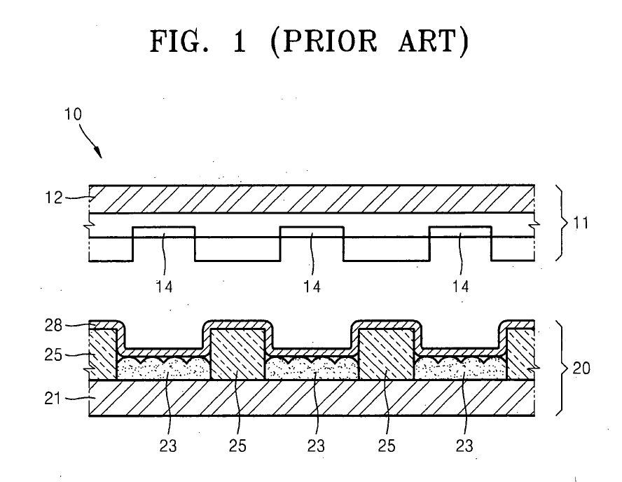

The metal reflective layer 120 is attached to and supported by the barrier ribs 118, and separated from the phosphor layer 113. The metal reflective layer 120 is not shaped along the surfaces of the barrier ribs 118 and the phosphor layer 113 unlike the conventional art (refer to FIG. 1), but has a flat and smooth surface shape without any irregular surface. The flat and smooth metal reflective layer 120 improves the efficiency of reflecting the visible light rays emitted from the phosphor layer 113, and thus, a brightness of the flat panel display is improved. In addition, even when a high voltage is supplied between the cathode 104 and the gate 108, a uniform electric field is formed on the flat metal reflective layer 120, and thus, an arc generation due to the electric field distortion and a damage of the flat panel display 100 due to the arc generation can be prevented.

In addition, since the metal reflective layer 120 and the phosphor layer 113 are separated from each other, the electrons (e−) can be evenly scattered through the metal reflective layer 120 even when the electrons (e−) are emitted unevenly from the emitters 109, and thus, the electrons (e−) can collide with the entire surface of the phosphor layer 113 evenly. Therefore, a uniformity of emission in a pixel can be improved.

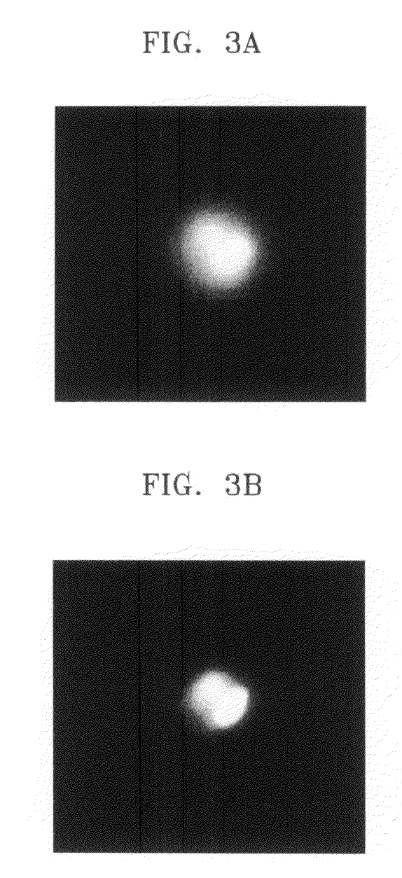

FIGS. 3A and 3B are photographs of emissions from a flat panel display including the metal reflective layer and from a flat panel display without the metal reflective layer. In more detail, FIG. 3A shows the emission from a pixel in the flat panel display, in which the metal reflective layer formed of Al is separated from the phosphor layer by 50 μm, a brightness difference between the emitting portion and the dark portion is smaller than that of FIG. 3B, and thus, the emission uniformity is improved. The brightness difference can be reduced due to the dispersion of the electrons by the metal reflective layer separated from the phosphor layer.

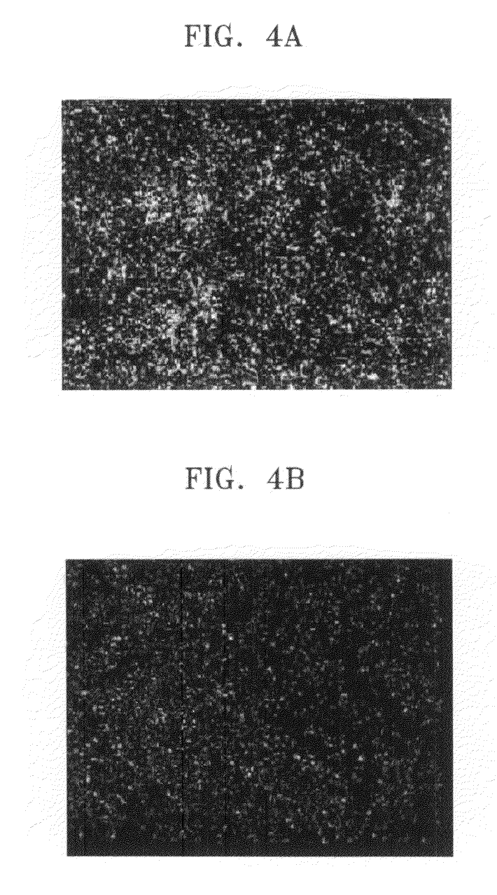

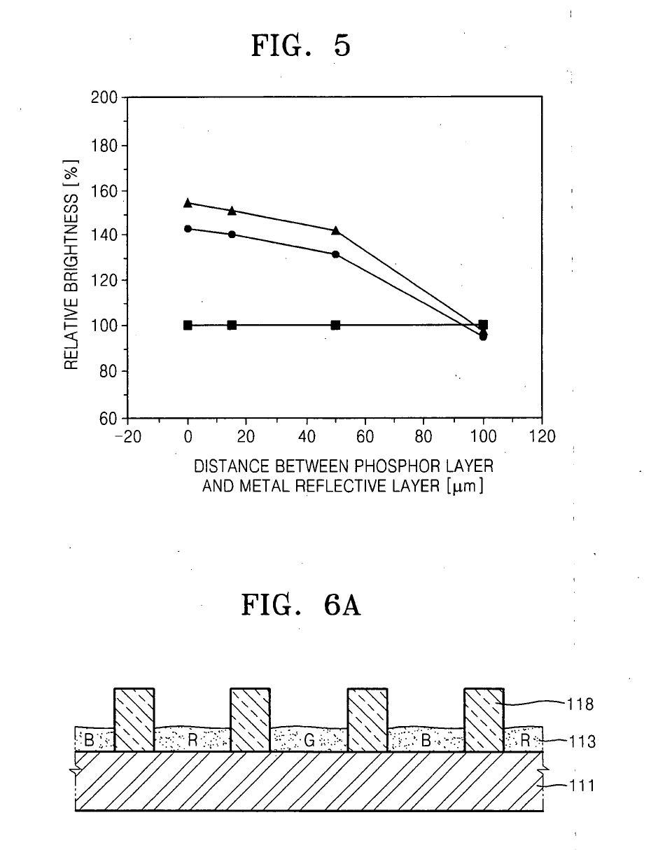

FIGS. 4A and 4B are microphotographs of a metal reflective layer having a relatively rough surface and a metal reflective layer having a relatively smooth surface. FIG. 5 is a graph of relative brightnesses of a flat panel display without a metal reflective layer, a flat panel display having a relatively rough surface, and a flat panel display having a relatively smooth surface.

In more detail, FIG. 4A is a photograph showing the metal reflective layer (hereinafter, first metal reflective layer) that is formed by applying a phosphor material on a substrate using a screen printing to form a phosphor layer, depositing a polymer layer on the phosphor layer, and depositing aluminum (Al) particles on the polymer layer. FIG. 4B is a photograph showing the metal reflective layer (hereinafter, the second metal reflective layer) that is formed by spin-coating a slurry of phosphor material on a substrate to form a phosphor layer, depositing a polymer layer on the phosphor layer, and depositing aluminum (Al) particles on the polymer layer. Comparing FIG. 4A with FIG. 4B, the second metal reflective layer has denser structure and smoother surface than the first metal reflective layer.

Referring to FIG. 5, the line plotted using square dots represents a relative brightness of the flat panel display that does not include the metal reflective layer, but the phosphor layer. The line plotted using circular dots represents a relative brightness of a flat panel display including the first metal reflective layer, and the line plotted using triangle dots represents a relative brightness of a flat panel display including the second metal reflective layer. From the graph of FIG. 5, the brightness of the flat panel display including the metal reflective layer is higher than that of the flat panel display that does not include the metal reflective layer.

In addition, the brightness of the flat panel display including the second metal reflective layer that has the smooth and flat surface is superior to that of the flat panel display including the first metal reflective layer by 7-8%. However, the improvement of the brightness when comparing to that of the flat panel display without the metal reflective layer is reduced as the distance between the phosphor layer and the metal reflective layer is long. When the distance between the phosphor layer and the metal reflective layer is 100 μm or longer, the brightness improvement that is caused by the metal reflective layer reflecting the visible light rays rarely occurs. The distance between the first metal reflective layer and the phosphor layer and the distance between the second metal reflective layer and the phosphor layer can be adjusted by changing the thickness of the polymer layer that is formed between the metal reflective layer and the phosphor layer.

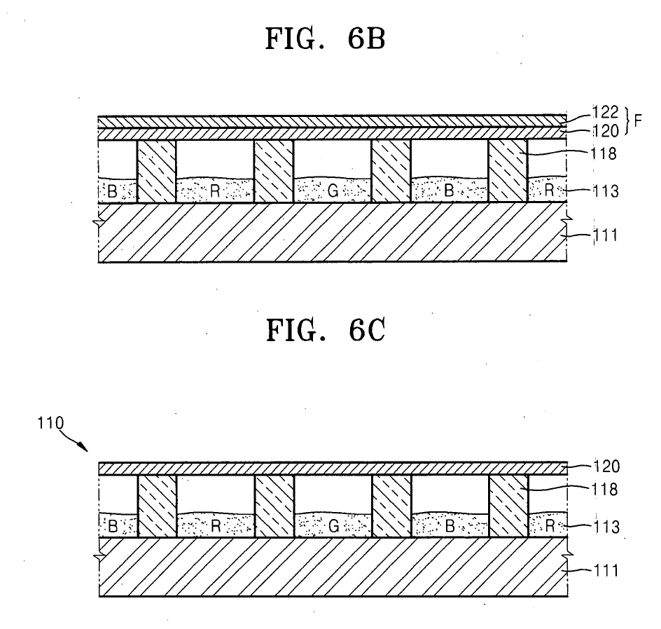

FIGS. 6A through 6C are cross-sectional views of processes of manufacturing the flat panel display of FIG. 2. A method of manufacturing the flat panel display according to an embodiment of the present invention is described below with reference to FIGS. 6A through 6C.

Referring to FIG. 6A, in order to manufacture the flat panel display (100 of FIG. 2) according to the embodiment of the present invention, the barrier ribs 118 and the phosphor layer 113 are formed on a rear surface of the transparent front substrate 111. The barrier ribs 118 can be formed by screen-printing one material selected from a group consisting of polymers, inorganic materials, and metallic materials on the rear surface of the front substrate 111. The phosphor layer 113 can be formed by spin-coating the slurry of phosphor material on the rear surface of the front substrate 111, or screen-printing the phosphor material on the rear surface of the front substrate 111. Red (R), green (G), and blue (B) lines of the phosphor layer 113 are can be clearly distinguished from each other, and thus, not mixed with each other because of the barrier ribs 118.

Next, the metal reflective layer 120 that is attached onto and supported by the barrier ribs 118 is formed using a metal transfer film (F). Referring to FIG. 6B, the metal transfer film F is formed by forming a polymer layer 122 on the substrate (not shown), depositing aluminum (Al) on the polymer layer 122 to form a metal layer 120, and then, separating the polymer layer 122 from the metal layer 120. The polymer layer 122 can be formed of a hydrophobic polymer, for example, poly alkyl acrylate, polydiene, and polyolefin, a hydrophilic polymer, for example, poly alkyl acid, poly acrylamide, and poly ethylene glycol, or multi-layered hydrophobic polymer and the hydrophilic polymer.

The metal transfer film F is placed to contact the barrier ribs 118 so that the metal layer 120 can face the phosphor layer 113, and then, the metal transfer film F is compressed toward the front substrate 111 at a temperature of 150° C. Then, the metal layer 120 is attached onto the barrier ribs 118 by the thermal transfer. Next, the polymer layer 122 is removed from the metal transfer film F using a solvent, and then, the flat and smooth metal reflective layer 120 that is separated from the phosphor layer 113 and attached to the barrier ribs 118 is formed as shown in FIG. 6C. If the polymer layer 122 is formed of the hydrophobic polymer, an organic solvent such as acetone can be used to remove the polymer layer 122. If the polymer layer 122 is formed of the hydrophilic polymer, water can be used as the solvent to remove the polymer layer 122.

Although it is not shown in the drawings, the metal reflective layer can be formed by depositing a polymer layer on the phosphor layer and the barrier ribs evenly, depositing metal particles such as aluminum on the polymer layer, and removing the polymer layer using a firing process.

The electron emission portion (101 of FIG. 2) is mounted on the light emission portion 110 manufactured as shown in FIG. 6C, and then, the flat panel display 100 can be manufactured. The electron emission portion 101 is mounted on the front substrate 111 so as to be separated from the metal reflective layer 120.

According to the flat panel display of the present invention, the brightness can be improved by the flat and smooth metal reflective layer. In addition, a uniform and flat electric field is formed on the metal reflective layer when the driving voltage is supplied, and thus, an arc generated due to the electric field distortion and a damage of the flat panel display due to the arc generation can be prevented.

In addition, in the flat panel display including the metal reflective layer that is separated from the phosphor layer according to the present invention, the uniformity of emitting light can be improved by the electron dispersion effect.

Also, according to the method of manufacturing the flat panel display, in which the metal reflective layer is formed using the metal transfer film, a firing process for removing the polymer layer is not required, and thus, manufacturing processes can be simplified and fabrication costs can be reduced.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. A flat panel display comprising:
an electron emission portion to emit electrons frontward; and
a light emission portion, arranged on a front portion of the electron emission portion, to emit visible light rays frontward, the light emission portion including:
a transparent front substrate to project the visible light rays toward the front portion;
a phosphor layer arranged on a rear surface of the front substrate, the phosphor layer emitting visible light upon receiving electrons emitted from the electron emission portion; and
a flat metal reflective layer arranged between the phosphor layer and the electron emission portion.

2. The flat panel display of claim 1, wherein the metal reflective layer is spaced apart from the phosphor layer.

3. The flat panel display of claim 2, wherein a distance between the metal reflective layer and the phosphor layer is in a range greater than 0 μm and less than 100 μm.

4. The flat panel display of claim 1, wherein the metal reflective layer comprises aluminum.

5. The flat panel display of claim 1, wherein the phosphor layer comprises a plurality of lines.

6. The flat panel display of claim 5, further comprising barrier ribs to separate adjacent lines of the phosphor layer.

7. The flat panel display of claim 6, wherein the metal reflective layer is attached to and supported by the barrier ribs.

8. The flat panel display of claim 1, wherein the metal reflective layer comprises a polymer layer stacked evenly on the phosphor layer, and metal particles arranged on the polymer layer.

9. The flat panel display of claim 1, wherein the metal reflective layer is formed by arranging a metal transfer film, including a polymer layer and a metal layer formed by depositing metal particles on the polymer layer, on the phosphor layer so that the metal layer faces the phosphor layer, and removing the polymer layer in the metal transfer film.

10. A method of manufacturing a flat panel display, the method comprising:
forming a phosphor layer, to emit visible light on receiving electrons, on a rear substrate of a transparent front substrate;
forming a flat metal reflective layer on the phosphor layer; and
arranging an electron emission portion, to emit electrons onto the phosphor layer, on the front substrate, the electron emission portion being spaced apart from the metal reflective layer.

11. The method of claim 10, wherein the metal reflective layer is spaced apart from the phosphor layer.

12. The method of claim 11, wherein a distance between the metal reflective layer and the phosphor layer is in a range greater than 0 μm and less than 100 μm.

13. The method of claim 10, wherein the metal reflective layer comprises aluminum.

14. The method of claim 10, wherein the phosphor layer is formed either by spin-coating a slurry of a phosphor material on the rear surface of the front substrate, or by screen-printing the phosphor material on the rear surface of the front substrate.

15. The method of claim 10, wherein the phosphor layer comprises a plurality of lines.

16. The method of claim 15, further comprising forming barrier ribs to separate adjacent lines of the phosphor layer.

17. The method of claim 16, wherein the metal reflective layer is attached to and supported by the barrier ribs.

18. The method of claim 17, wherein the barrier ribs are formed by screen-printing one material, selected from a group consisting of polymers, inorganic materials, and metallic materials, on the rear surface of the front substrate.

19. The method of claim 10, wherein forming the metal reflective layer comprises:
evenly stacking a polymer layer on the phosphor layer; and
arranging metal particles on the polymer layer.

20. The method of claim 10, wherein forming the metal reflective layer comprises:
arranging a metal transfer film, including a polymer layer and a metal layer formed by depositing metal particles on the polymer layer, on the phosphor layer so that the metal layer faces the phosphor layer; and
removing the polymer layer in the metal transfer film.
